(19) United States
(12) Patent Application Publication
(10) Pub. No.: US 2022/0194417 A1
(43) Pub. Date: Jun. 23, 2022

(54) METHOD FOR AUTONOMOUS DRIVING START-UP OF A MOTOR VEHICLE

(71) Applicant: RENAULT s.a.s, Boulogne-Billancourt (FR)

(72) Inventors: David GONZALEZ BAUTISTA, Saint Cyr l'ecole (FR); Imane MAHTOUT, Sarcelles (FR); Vicente MILANES, Boulogne-Billancourt (FR); Francisco Martin NAVAS MATOS, Paris (FR)

(73) Assignee: RENAULT s.a.s., Boulogne-Billancourt (FR)

(21) Appl. No.: 17/640,946

(22) PCT Filed: Aug. 21, 2020
(86) PCT No.: PCT/EP2020/073484

§ 371 Date: Mar. 7, 2022

(30) Foreign Application Priority Data
Sep. 10, 2019 (FR) FR1909974

(51) Int. Cl. B60W 60/00; B60W 40/105; B62D 15/02

(52) U.S. Cl. CPC B60W 60/001; B60W 60/0051; B60W 2554/4041; B62D 15/021; B60W 2520/28; B60W 40/105

(57) ABSTRACT

A method of autonomous driving for low-speed or zero-speed maneuvering of a motor vehicle includes modifying the orientation of the steerable wheels of the vehicle while the speed of the vehicle is zero or substantially zero, or less than or equal to a threshold, in particular a threshold equal to 1 km/h.

### TECHNICAL FIELD OF THE INVENTION

The invention relates to a method for the autonomous driving or autonomous control of a motor vehicle. The invention also relates to a system for the autonomous driving or autonomous control of a motor vehicle. The invention also relates to a motor vehicle comprising such an autonomous driving system or comprising hardware and/or software means implementing such an autonomous driving method. The invention further relates to a computer program product comprising program code instructions recorded on a support that can be read by an electronic control unit to implement the steps of the autonomous driving method. The invention also relates to a data recording support that can be read by an electronic control unit and on which the program product is recorded. The invention finally relates to a signal from a data support, bearing the computer program product.

In particular, the invention relates to an accurate method for autonomous driving in order to begin a journey in autonomous mode in a situation of low speed of travel of the vehicle and regardless of the situation surrounding the vehicle. This solution solves a problem of a lack of alignment of the vehicle at the time of starting or in a bend. The solution significantly increases the autonomous nature of the vehicle.

### PRIOR ART

An autonomous motor vehicle is able by itself to manage the trajectory along which it is moving without action on the part of a user of the vehicle, except for indicating to the vehicle an arrival point or an end-of-journey point. To this end, an autonomous vehicle generally comprises an autonomous driving mode, managed by an autonomous driving system, able to guide it.

The autonomous driving mode manages the control of various actuators that allow the vehicle to move along a trajectory. These actuators are chiefly the power unit that drives the motor vehicle and a steering actuator able to adequately orient the steered wheels of the vehicle.

An autonomous vehicle generally comprises an autonomous cruising driving mode, managed by an autonomous cruising driving system, able to guide it at cruising speeds, for example speeds in excess of 30 km/h, or even in excess of 50 km/h. This mode is used in town on main roads and out of town on highways or freeways. The autonomous cruising driving mode is activated only once the autonomous vehicle has already reached a cruising speed. Thus, when the vehicle is starting or pulling away or the vehicle is pulling out (starting from near a kerb for example) or the vehicle is pulling in (parking near a kerb for example) and more generally when maneuvering at low speed, which is to say at speeds below 10 km/h or even below 5 km/h, it is a driver or a remote operator who drives the vehicle.

On-demand mobility services are designed to transport individuals door to door so as to offer the passengers the comfort of being picked up and set down wherever they wish. However, these services require autonomous vehicles capable of managing automated maneuvers involving extremely precise longitudinal and transverse commands, especially during the pulling-in or pulling-out maneuvers, in order to keep the vehicle close enough to the kerb while at the same time avoiding injury to the users or to third parties or material damage to the autonomous vehicle, to other surrounding vehicles or to surrounding infrastructures. These maneuvers are complex because they require precise longitudinal and lateral positioning data at very low speed. These requirements are not met by the autonomous driving systems currently available. The autonomous driving systems are in effect dedicated to extra-urban roadways and can be activated once the vehicle is in circulation. However, when the vehicle is stationary or running at a low speed and the autonomous driving system is activated, the trajectory is poorly managed and there are significant risks of injury or damage as a result of the movement of the vehicle.

For good management of low-speed maneuvers autonomously, precise low-speed control is of the utmost importance. Specifically, during these maneuvers, small steering radii are required whereas the dynamic data and current status of the vehicle are neglected.

Just after activating the autonomous mode for a vehicle circulating at zero or substantially zero speed, the vehicle may be impeded by unforeseen circumstances forcing a remote operator to take over control of the vehicle in order to solve the problem. This problem set is due to an (excessively) approximate estimate of the state of the vehicle in which, for example, the heading, the direction of the wheels or the lateral position error may be neglected. This leads to the calculation of a trajectory which may be unattainable, for example being outside of the capabilities of the vehicle.

In other words, starting from a zero or substantially zero speed and up to a cruising speed, a vehicle is not autonomous. This results in the need to be able to call upon a driver within the vehicle, or even a remote operator, particularly when the vehicle arrives at a platform or kerb (pulls in) to set down and/or pick up passengers, or when the vehicle is starting from a platform or kerb (pulling out) or else for effecting complex maneuvers.

Document U.S. Pat. No. 9,645,577 discloses a guidance system designed to autonomously guide the vehicle in a constrained environment. The system generates various spatiotemporal trajectory solutions as different movement strategies so that the vehicle chooses the one that appears to be optimal. Once the strategy has been determined, the necessary commands for following it are sent to the actuators of the vehicle. One disadvantage with this solution is that, at low speed, it may choose a trajectory that cannot be realized given the current state of certain actuators.

### Introduction to the Invention

It is an object of the invention to provide an autonomous driving method that overcomes the above disadvantages and improves the driving methods known from the prior art. In particular, the invention makes it possible to produce an autonomous vehicle capable of autonomously managing complex maneuvers performed at low speeds of travel of the vehicle.

### SUMMARY OF THE INVENTION

In order to achieve this objective, the invention relates to a method for the autonomous maneuvering driving of a motor vehicle, notably a method for the autonomous maneuvering driving of a motor vehicle at low speed or zero speed, comprising a step of modifying the orientation of the steered wheels of the vehicle while the speed of the vehicle is zero or substantially zero or below or equal to a threshold, notably a threshold equal to 1 km/h.

The step of modifying the orientation of the steered wheels of the vehicle can be implemented:
just after a step of activating an autonomous driving mode, and/or
before a step of driving or moving the vehicle in autonomous mode along a maneuvering trajectory.

The invention also relates to a method for the autonomous driving of a motor vehicle, comprising:
an autonomous maneuvering driving mode comprising implementation of the method as defined hereinabove, and
an autonomous cruising driving mode for cruising along a cruise trajectory, the two autonomous driving modes being exclusive.

The operating logic for the autonomous maneuvering driving mode and for the autonomous cruising driving mode may be different; and/or in autonomous maneuvering driving mode the vehicle may be driven or moved at a speed below 10 km/h, or even below 5 km/h.

The method may comprise:
a step of defining a reference cruise trajectory, and
a step of defining, notably a step of defining iteratively and/or by simulation, the maneuvering trajectory, in particular to meet the reference cruise trajectory from an initial position of the vehicle.

The method may comprise a step of validating the maneuvering trajectory with respect to:
the physical maneuvering capabilities of the vehicle, and/or
the safety of the assets and/or individuals in the vehicle and/or in the vicinity of the vehicle.

The method may comprise:
a step of determining or measuring the current position of the vehicle, particularly the current location and/or the current heading,
a step of comparing the current position of the vehicle and positions that make up the reference trajectory,
a step of automatically switching over from the autonomous maneuvering driving mode to the autonomous cruising driving mode when the current position of the vehicle corresponds or is considered to correspond to one of the positions that make up the reference trajectory.

The invention further relates to a system for the autonomous driving of a motor vehicle, the system comprising hardware and/or software elements implementing the method as defined hereinabove, notably hardware elements and/or software elements designed to implement the method as defined hereinabove, and/or to a system comprising means for implementing the method as described hereinabove.

The invention further relates to a motor vehicle, the vehicle comprising hardware and/or software elements implementing the method as defined hereinabove, notably hardware elements and/or software elements designed to implement the method as defined hereinabove, and/or to a vehicle comprising means for implementing the method as defined hereinabove.

The invention further relates to a computer program product comprising program code instructions recorded on a support readable by an electronic control unit for implementing the steps of the autonomous driving method as defined hereinabove when said program is operating on an electronic control unit or to a computer program product that can be downloaded from a communications network and/or recorded on a data support that can be read by a computer and/or executed by a computer, comprising instructions which, when the program is executed by the computer, cause the latter to implement the method as defined hereinabove.

The invention further relates to a data recording support, that can be read by an electronic control unit and on which is recorded a computer program comprising program code instructions for implementing the method as defined hereinabove or to a recording support that can be read by a computer comprising instructions which, when executed by a computer, cause the latter to implement the method as defined hereinabove.

The method further relates to a signal from a data support bearing the computer program product as defined hereinabove.

### DESCRIPTION OF THE FIGURES

These objects, features and advantages of the present invention will be set out in detail in the following description of one particular embodiment given without implying limitation and in connection with the attached figures among which:

FIG. 1 is a schematic view of one embodiment of an autonomous vehicle.

FIG. 2 is a partial schematic view of one embodiment of a system for autonomous driving of the autonomous vehicle.

FIG. 3 is another partial schematic view of the embodiment of the system for autonomous driving of the autonomous vehicle.

FIG. 4 is a view from above illustrating a trajectory of an autonomous vehicle equipped with the embodiment of the autonomous driving system in the context of a roundabout and a trajectory of an autonomous vehicle not equipped with the embodiment of the autonomous driving system in the same context.

FIG. 5a FIG. 5a is a graph illustrating the angle of a steering wheel of an autonomous vehicle equipped with the embodiment of the autonomous driving system in the context of a roundabout and the angle of a steering wheel of an autonomous vehicle not equipped with the embodiment of the autonomous driving system in the same context.

FIG. 5b FIG. 5b is a graph illustrating the speed of an autonomous vehicle equipped with the embodiment of the autonomous driving system in the context of a roundabout and the speed of an autonomous vehicle not equipped with the embodiment of the autonomous driving system in the same context.

FIG. 5c FIG. 5c is a graph illustrating the lateral error of an autonomous vehicle equipped with the embodiment of the autonomous driving system in the context of a roundabout and the lateral error of an autonomous vehicle not equipped with the embodiment of the autonomous driving system in the same context.

FIG. 5d FIG. 5d is a graph illustrating the heading error of an autonomous vehicle equipped with the embodiment of the autonomous driving system in the context of a roundabout and the heading error of an autonomous vehicle not equipped with the embodiment of the autonomous driving system in the same context.

FIG. 6 FIG. 6 is a view from above illustrating a trajectory of an autonomous vehicle equipped with the embodiment of the autonomous driving system in the context of a bend and a trajectory of an autonomous vehicle not equipped with the embodiment of the autonomous driving system in the same context.

FIG. 7a FIG. 7a is a graph illustrating the angle of a steering wheel of an autonomous vehicle equipped with the embodiment of the autonomous driving system in the context of a bend and the angle of a steering wheel of an autonomous vehicle not equipped with the embodiment of the autonomous driving system in the same context.

FIG. 7b FIG. 7b is a graph illustrating the speed of an autonomous vehicle equipped with the embodiment of the autonomous driving system in the context of a bend and the speed of an autonomous vehicle not equipped with the embodiment of the autonomous driving system in the same context.

FIG. 7c FIG. 7c is a graph illustrating the lateral error of an autonomous vehicle equipped with the embodiment of the autonomous driving system in the context of a bend and the lateral error of an autonomous vehicle not equipped with the embodiment of the autonomous driving system in the same context.

FIG. 7d FIG. 7d is a graph illustrating the heading error of an autonomous vehicle equipped with the embodiment of the autonomous driving system in the context of a bend and the heading error of an autonomous vehicle not equipped with the embodiment of the autonomous driving system in the same context.

FIG. 8 illustrates an example of a man-machine interface of the embodiment of the autonomous driving system.

FIG. 9 is a flowchart of one way of executing an autonomous driving method.

### DETAILED DESCRIPTION

FIG. 1 schematically illustrates one embodiment of a vehicle 300, particularly a motor vehicle. The vehicle 300 may for example be a private vehicle, a utility vehicle, a truck or a bus.

The vehicle 300 comprises an autonomous driving system 200. The autonomous driving system is able to manage an autonomous maneuvering driving mode. This autonomous maneuvering driving mode is able to manage the autonomous movement of the motor vehicle at low speed, notably during complex maneuvers such as pulling-in maneuvers or pulling-out maneuvers. Advantageously, the autonomous driving system is also able to manage a second autonomous driving mode: an autonomous cruising driving mode. This autonomous cruising driving mode is able to manage the autonomous movement of the motor vehicle at high speed, notably during extra-urban travel on highways or freeways or on major traffic routes in an urban environment.

The autonomous driving system 200 comprises:
a computer 100,
a set of actuators 220,
a set of elements 10, 11, 12, 13, 14, 15 supplying information as to the state and surroundings of the vehicle.

Advantageously, the autonomous driving system 200 may also comprise a man-machine interface 210. For example, the man-machine interface is able to inform a user, a passenger or a remote operator of the feasibility of autonomously executing a maneuver and/or of the way in which the commands of the actuators of the vehicle are corrected in order to adjust the trajectory.

The set of actuators notably comprises a steering actuator 221 or actuator of the orientation of the steered wheels of the vehicle 300, and a drive unit 222 that powers the vehicle 300. The vehicle drive unit may be of the combustion engine, hybrid drive unit or electric motor type.

The set of elements 220 supplying information regarding the state and surroundings of the vehicle may comprise one or more of the following elements:
a traffic lane sensor 10,
an obstacle sensor 11,
a sensor 12 of the steering or of the orientation of the steered wheels,
a vehicle speed sensor 13,
a vehicle position sensor 14,
a module 15 supplying a reference trajectory.

One or more of the sensors may be replaced by an element providing equivalent information, for example replaced by an estimator.

The position sensor 14 or a position estimator advantageously provides information as to the location of the vehicle, such as GPS coordinates, and information of the orientation of the vehicle or the heading of the vehicle, such as for example the orientation of the longitudinal axis of the vehicle.

The computer 100 therefore uses as main inputs:
the information coming from sensors on board the vehicle (such as the current speed and the current steering wheel angle or the current angle of orientation of the steered wheels), and/or
the information coming from a camera or from other devices able to detect the lines demarcating traffic lanes, and/or
the information coming from any perception system comprising a camera, a radar, an ultrasound device, a lidar device or a combination of these to detect any short-range obstacle and/or
the information coming from a vehicle positioning system able to supply the current position of the vehicle and the heading and a given reference trajectory such as a series of points that the vehicle is to follow.

From all of this information it is possible to calculate:
an available driving area. This area represents the limits that the vehicle is not to exceed when beginning the maneuver autonomously. If the vehicle is outside of this area, that means that a collision may occur. This information may be supplied by merging information from the lane sensor or detector 10 and the obstacle sensor or detector 11. This information can be used subsequently in a pull-away or start validation module 1 (see below) in order to authorize or stop the maneuver.
a current state of the vehicle. This current state includes the current orientation of the steered wheels, for example by measuring the current angle of the steering wheel. Not only the current heading of the vehicle but also the orientation of the steered wheels of the wheels play a key role in increasing the maneuverability of the vehicle.
a reference trajectory. This reference trajectory is supplied for example by an autonomous driving path prediction module or by a remote operator in the event that the vehicle is in an assisted mode on account of an unknown environment.

The computer 100 comprises:
a pull-away or start validation module 1 able to determine the feasibility of a maneuver in autonomous maneuvering mode and/or to determine whether the vehicle can start or pull away autonomously with sufficient safety conditions,
a command simulation module 2 able to simulate commands for controlling actuators of the vehicle, in particular a command for controlling the vehicle drive unit and a command for controlling the actuator that orients the steered wheels of the vehicle,
a trajectory following module 3 able to correct the actuator control commands, particularly while executing the maneuver in autonomous maneuvering mode.

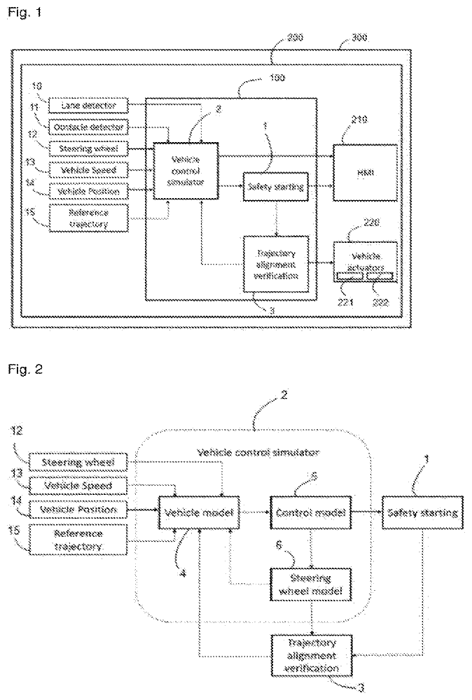

As illustrated in FIG. 2, one embodiment of the command simulation module 2 comprises:
a vehicle modelling module 4,
a command modelling module 5, and
a steering modelling module 6.

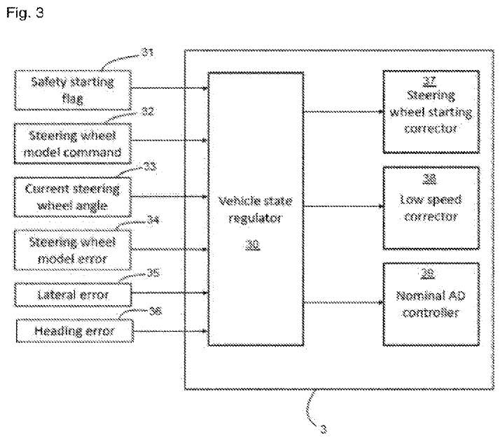

As illustrated in FIG. 3, one embodiment of the trajectory following module 3 comprises:
a command regulator 30,
an initial steering command correction module 37,
a position correction module 38, and
an autonomous cruising driving mode module 39.

The trajectory following module 3 and more specifically the command regulator 30 receives at input the signals and/or information which follow:
pull-away or start validation information 31,
steering command model information 32,
vehicle steered wheels current angular orientation information 33,
steering command model error information 34,
vehicle lateral position error information 35,
vehicle heading or orientation error information 36.

The motor vehicle, particularly the autonomous driving system and/or the computer, comprise hardware and/or software means able or configured to implement the method that forms the subject matter of the invention.

The hardware and/or software means may comprise software modules.

One mode of execution of an autonomous driving method is described hereinafter with reference to FIG. 9.

This mode of execution may also be seen as a mode of execution of a method of operation of the vehicle or of the autonomous driving system. This mode of execution is described here in detail as being a mode of execution of a method of operation of the autonomous driving system.

It is assumed that the vehicle is initially stationary after one or more passengers have met the vehicle and climbed aboard in order to be driven by the vehicle to a destination of their choice. It is also assumed that the vehicle is in an environment in which there are obstacles and which therefore requires a complex maneuver so that it can start or pull away or pull out.

It is also assumed that the vehicle or the autonomous driving system has a reference trajectory or has calculated a reference trajectory. The reference trajectory is a trajectory allowing the vehicle to go from a start point to an arrival point following or substantially following the lines of the traffic lanes. Thus, when a vehicle follows a reference trajectory, it is centered or substantially centered on the traffic lane. Such a trajectory is incompatible with a vehicle state in which the vehicle is parked near a kerb, in an interior courtyard or in a parking lot, which is to say that, in such situations, the position (location and heading) of the vehicle does not correspond to any of the positions defined by the reference trajectory.

In a first phase 110, the autonomous driving system operates in an autonomous maneuvering driving mode and simulates the state of the vehicle, vehicle actuator commands and a maneuvering trajectory.

The maneuvering trajectory is a vehicle trajectory that allows the vehicle to meet the reference trajectory from its initial state, for example a state of being parked near a kerb, in an interior courtyard or in a parking lot.

As illustrated in FIGS. 1 and 2, various items of information are supplied to the command simulation module 2. This enables the creation of a virtual model of the vehicle corresponding to the current state of the vehicle. The vehicle model is created with the same position as the actual vehicle, but the vehicle model is assigned a minimal speed to enable the calculation of the actuator commands, notably a command for an actuator that orients the steered wheels, to follow the reference trajectory. In this vehicle model, the orientation of the steered wheels (and therefore the position of the steering wheel) is constantly corrected up to the moment at which the trajectory following module 3 indicates that the determined commands for controlling the actuators allow the maneuver to start correctly or that an actuator command has reached a physical limit of the vehicle (for example a steering wheel angle indicating maximum right or left lock).

Steps of a mode of execution of this first phase 110 are described in greater detail hereinafter.

In a first step, the actuator command simulation module 2, particularly the vehicle modelling module 4, receives as input all or part of the following information:
current information as to the orientation of the steered wheels (sensor 12) This information enables the simulation of a vehicle trajectory in the absence of correction of the current orientation of the steered wheels by the autonomous driving system.
vehicle speed information (sensor 13). This information may come from onboard sensors to confirm that the vehicle is completely or substantially stopped. For example, the autonomous maneuvering driving mode is deactivated when the vehicle is running at a cruising speed. In this case an autonomous cruising driving mode may be activated, this autonomous cruising driving mode making it possible to manage errors with respect to the reference trajectory.
vehicle positioning information which may be supplied either at local level (for example using a camera) or at global level (for example based on a GPS) (sensor 14). That makes it possible to know the current position of the vehicle and its heading. These items of information are of course connected to the orientation of the steered wheels of the vehicle.
the reference trajectory already mentioned above which comes from the module 15 that supplies this reference trajectory. This module may form part of the system allowing implementation of the autonomous cruising driving mode that uses this reference trajectory. Alternatively, this reference trajectory may be transmitted by a remote operator in the event that the vehicle is being assisted.

In a second step, the reference trajectory is used to virtually model the vehicle using the vehicle modelling module 4 by giving the vehicle a minimal speed but without causing the position of the vehicle to move virtually. What that means is that the modelled virtual vehicle is still in the same virtual position (for example having identical longitude, latitude and heading values).

In a third step, the command modelling module 5 corrects the steered wheels orientation error that there is between the current orientation of the steered wheels and the orientation necessary for following the reference trajectory. In consequence, the command modelling module 5 generates a command for controlling the vehicle steered wheels orientation actuator.

In a fourth step, this command generated in the third step is supplied to the steering modelling module 6 which, on this basis, is able to generate a future change to the position of the virtual vehicle in order to verify the future values of the positions (longitude, latitude and heading) of the vehicle with respect to the limits of the driving area available in the vicinity of the vehicle. A verification is then made as to whether the last command generated leads to a virtual orientation of the steered wheels that allows a desired point on the reference trajectory to be attained or whether the command generated exceeds the physical capabilities of the vehicle in terms of vehicle wheel orientation angle. If the check is not ok, the method loops back to the third step and the third and fourth steps are repeated iteratively until:
first scenario: the last command generated leads to a virtual orientation of the steered wheels that allows a desired point on the reference trajectory to be attained, or
second scenario: the command generated exceeds the physical capability of the vehicle in terms of the angular orientation of the wheels of the vehicle.

Thus, the method comprises a step of validating the maneuvering trajectory against the physical maneuvering capabilities of the vehicle.

In the first scenario, the method moves on to a second phase 120. The last value for the command of the actuator for orienting the wheels of the vehicle is retained.

In the second scenario, the autonomous driving system has not found an actuator command that allows the maneuver to be performed. In consequence, the autonomous driving system informs a user of the vehicle or a remote operator of this fact. This information is communicated for example via the man-machine interface 210.

Thus, in this first phase, the method comprises:
a step of defining or receiving the reference cruise trajectory, and
a step of defining, notably a step of defining iteratively and/or by simulation, the maneuvering trajectory, particularly in order to meet the reference cruise trajectory from an initial position of the vehicle.

In the second phase 120, the autonomous driving system tests whether the complex maneuver can be realized in autonomous mode or whether the maneuver can be realized with a sufficient level of safety to the individuals and assets in the vehicle and in the external environment in the vicinity of the vehicle. If it can, the autonomous driving system implements a phase 130. If it cannot, the autonomous driving system implements a phase 140. Thus, in this second phase 120, the autonomous driving system evaluates the vehicle and the actuator commands determined previously (by the command simulation module 2) to generate the virtual trajectory that the vehicle is to cover. The virtual trajectory is verified by the pull-away or start validation module 1 to ensure a safe start (for example that the foreseen future positions of the vehicle will lie inside the driving area). To do this, a vehicle speed is used to simulate the future changes to the position of the virtual vehicle during the course of the maneuver. This speed can be parameterized. It is for example fixed at 2 m/s.

Advantageously, the autonomous driving system may command for certain ones of the iterations or all of the iterations (until a maneuver that can be realized is or is not found) to be displayed and/or illustrated on the man-machine interface. As a preference, the autonomous driving system may command for the man-machine interface to display information relating to the performance of the autonomous driving system, for example a simultaneous display of the last virtual trajectory adopted and of the reference trajectory supplied by the module 15 or a simultaneous display of the last calculated initial orientation of the steered wheels of the vehicle and of the current orientation of the steered wheels of the vehicle. As a preference, the autonomous driving system may command for the man-machine interface to display:
a safe start indicator to indicate that an actuator control for autonomously performing a maneuver safely or without collision has been found, and/or
an autonomous path start warning indicator, and/or
an assistance indicator indicating to a user and/or to a remote operator that manual/external intervention is of use.

Thus, the method comprises a step of validating the maneuver trajectory with respect to the safety of the assets and/or individuals in the vehicle and/or in the vicinity of the vehicle.

In the phase 130, the autonomous driving system generates and executes the actual commands for controlling the actuators of the vehicle so as to execute the complex maneuver. When a validation indicator indicates that a safe start maneuver is possible, the autonomous driving system activates the trajectory following module 3. This module receives the virtual commands determined by the command simulation module 2 and allowing the maneuver to be executed according to the determined virtual trajectory. The validation indicator thus stops the iterative calculations of the vehicle actuator command simulation module 2, adopting the last simulated actuator command values. Next, a three-step procedure is implemented by the trajectory following module 3:
The last simulated commands of the actuators (particularly the last simulated command of the actuator for orienting the steered wheels) are considered to be the initial commands that are applied to the actuators at the start of execution of the maneuver. However, these commands are applied with the vehicle stationary, namely at zero speed. The autonomous driving system here defines the initial steering angle value or the initial value for the orientation of the steered wheels that the vehicle needs to have while maintaining a zero speed. This step minimizes the difference between the virtual steering command of the steered wheels and the actual steering of the steered wheels when beginning to implement the maneuver. When this difference is below a given threshold, the autonomous driving system may execute the maneuver and the vehicle may start its journey autonomously. This phase is important because it allows correction for defective alignment (for example a vehicle with a lateral position error and/or a heading error that is significant in relation to the virtual trajectory, and/or a steered wheels orientation error) before the vehicle moves, allowing the maneuver to begin in the correct direction.
A minimum speed (for example 1 km/h or even 10 km/h) is fixed so that the vehicle can delicately correct any defective alignment there might be.
Angular and/or lateral error thresholds are determined and supplied in order to define the moment at which the vehicle is considered to have now correctly corrected its initial position and be in a situation in which autonomous cruising driving mode can then be activated.

Such a procedure is well accepted by users and does not catch them by surprise.

Steps (already mentioned hereinabove) of a mode of execution of this third phase 130 are described in greater detail hereinafter.

In a first step, the trajectory following module 3, particularly the command regulator 30, receives at input all or some of the following information:
pull-away or start validation information 31. This information indicates that a safe start is possible. It indicates that the maneuver can be executed autonomously and safely.
steering command model information 32. This information contains the last command to the actuator for orienting the steered wheels of the vehicle, calculated during the last iteration of the third step of the first phase 110.
vehicle steered wheels current angular orientation information 33.
steering command model error information 34. This information contains the difference between the current orientation of the steered wheels of the vehicle and the orientation of the steered wheels of the virtual vehicle.
vehicle lateral position error information 35.

This information contains a value for the distance separating the reference trajectory from the center of gravity of the vehicle.
vehicle orientation or heading error information 36. This information contains a value for the angle between the longitudinal axis of the vehicle and the tangent to the reference trajectory.

All of these inputs allow the regulator 30 to activate the various command actions according to the state of the vehicle.

Thus, in the first step of the third phase 130, the initial direction command correction module 37 has the task of minimizing the steering command model error value 34. It imposes a zero or substantially zero speed on the vehicle for as long as the orientation of the steered wheels of the vehicle are being corrected in order to achieve the orientation determined at the end of the first phase. The method therefore comprises a step of modifying the orientation of the steered wheels of the vehicle while the speed of the vehicle is:
zero, or
substantially zero, or
below or equal to a threshold, notably a threshold equal to 1 km/h.

This step of modifying the orientation of the steered wheels of the vehicle is implemented:
just after activation of the autonomous driving mode, and/or
before the vehicle is driven or moved in autonomous mode along a maneuvering trajectory.

Advantageously, once the value of the error 34 is below a predetermined threshold, the regulator 30 deactivates the module 37.

Next, in the second step of the third phase 130, the regulator 30 activates the position correction module 38. This module 38 fixes a given speed (for example 2 m/s and/or for example identical to the speed used in the first phase 110). In consequence, the vehicle moves actually driven by its drive unit so as to correct the position errors, particularly so as to correct the heading error and the lateral position error that there are with respect to the point of the reference trajectory to be met. The maneuver is therefore executed in autonomous mode. In autonomous maneuvering driving mode, the vehicle is preferably driven or moved at a speed below 10 km/h, or even below 5 km/h. The vehicle position error values are preferably constantly measured and/or estimated and then compared against their predetermined respective thresholds (typically 30 cm in the case of the lateral position error and 0.1 radian in the case of the heading error). When all the position error values are below their predefined thresholds, the regulator 30 deactivates the module 38. The maneuver is completed.

Next, in the third step of the third phase 130, the regulator 30 activates the autonomous cruising driving mode module 39.

The method therefore comprises:
a step of determining or measuring the current position of the vehicle, particularly the current location (latitude, longitude) and/or the current heading,
a step of comparing the current position of the vehicle and positions that make up the reference trajectory,
a step of automatically switching over from the autonomous maneuvering driving mode to the autonomous cruising driving mode when the current position of the vehicle corresponds or is considered to correspond to one of the positions that make up the reference trajectory.

Thus, the autonomous driving method allows the automatic, and/or without user action, transition from an autonomous maneuvering driving mode to an autonomous cruising driving mode. The method therefore comprises:
an autonomous maneuvering driving mode notably comprising implementation of the first step of the third phase 130, and
an autonomous cruising driving mode, the two autonomous driving modes being exclusive.

As a preference,
the operating logic for the autonomous maneuvering driving mode and for the autonomous cruising driving mode are different; and/or
in autonomous maneuvering driving mode the vehicle is driven or moved at a speed below 10 km/h, or even below 5 km/h, and/or
in autonomous cruising driving mode the vehicle is normally (without disturbance, notably without disturbances connected with the traffic) driven or moved at a speed equal or substantially equal to the authorized speed limit for that traffic lane.

In a phase 150, the autonomous driving system tests whether the vehicle is on a trajectory defined by an autonomous cruising driving mode, and if it is, the autonomous driving system exits the autonomous maneuvering driving mode and automatically switches over to this autonomous cruising driving mode.

In the phase 140, the autonomous driving system has not found an actuator command that allows the maneuver to be performed with satisfactory criteria. In consequence, the autonomous driving system informs the vehicle user or an operator of this fact. This information is communicated for example via the man-machine interface. The control of the actuators of the vehicle is then performed by the user of the vehicle or by the operator, notably a remote operator, in order to realize the maneuver.

In a phase 160, once the maneuver has been performed and with the vehicle in motion, the autonomous cruising driving mode can be activated. This autonomous cruising driving mode is activated by action on the part of the user or of the operator.

Thus, the autonomous driving system is capable of recognizing and taking into account misalignments between the position of the vehicle, the state of an actuator and the desired trajectory before beginning to execute any maneuver. The autonomous driving system commands and modifies the response of the vehicle (if need be) when the autonomous maneuvering mode is engaged and/or the speed is low so as to detect and correct dangerous situations when the vehicle is starting while its state is not consistent with the trajectory. The autonomous driving system continuously monitors the state of the vehicle and compares it against a reference trajectory in order to determine the feasibility thereof, modifying the actuator control commands accordingly in order to improve the following of the trajectory and reduce the risks.

The above-described embodiment of the autonomous driving system was coded and integrated into a vehicle belonging to the applicant (ZOE® robot taxi) and tests yielded the following results.

The system was tested on track with different initial states and different orientations of the vehicle. The results were compared against those obtained with the same vehicle without implementing the invention. These results demonstrate a significant improvement in the autonomy capabilities of the vehicle.

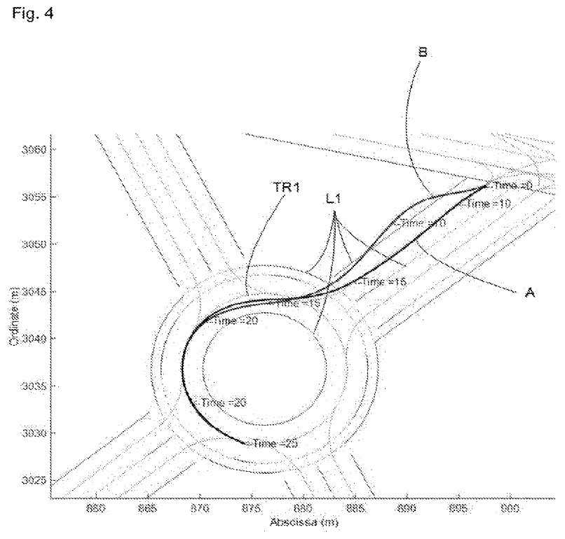

FIG. 4 shows a first situation in which the initial situation of the vehicle with respect to the reference trajectory is characterized by a small error in alignment on the lane used (the right-hand lane) and the steering wheel is on full right lock near to entering a roundabout. The desired trajectories TR1 and the limits L1 of the road are depicted respectively. Durations are indicated from zero (start point) up to 25 seconds following the same representation. A curve B represents the trajectory of the vehicle as obtained with the autonomous driving mode without the proposed invention, whereas a curve A represents the trajectory of the vehicle as obtained with the autonomous driving mode equipped with the autonomous maneuvering driving system described hereinabove.

It may be noted that kerb B immediately leaves the lane. The trajectory remains out of the lane for a long moment before returning to follow the desired reference trajectory (to make a U-turn around the roundabout). By contrast, curve A remains in lane. Specifically, with the solution according to the invention, the steered wheels of the motor vehicle are oriented first of all before the motor vehicle is moved. This allows the vehicle to enter the roundabout correctly starting from the same initial configuration.

It is important to note that the good stability capabilities of the autonomous driving system never put the vehicle in unstable situations. The significant lateral position and heading errors are due to the autonomous driving mode being initialized with the vehicle in a non-optimal state and the associated actuator data.

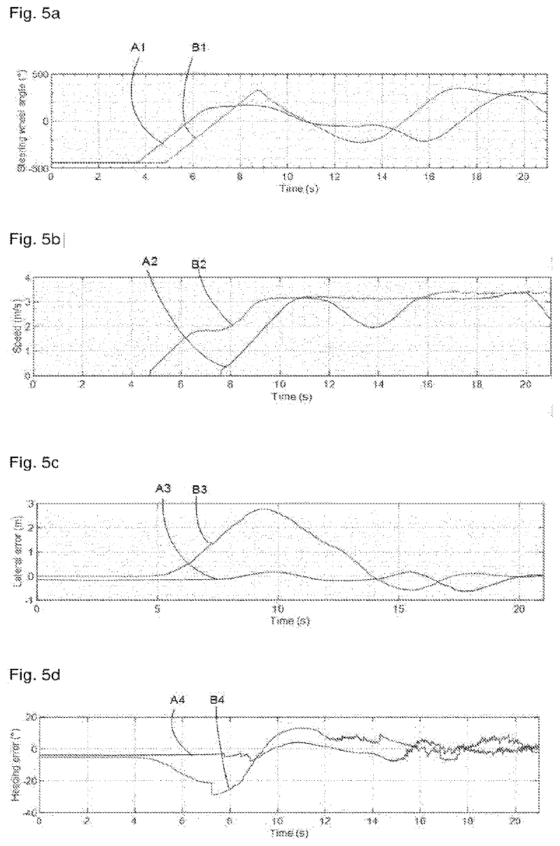

FIGS. 5a, 5b, 5c and 5d show the performance of the vehicle during the two tests described hereinabove.

FIG. 5a shows the changes in steering wheel angle from an initial value of −430 degrees during the course of the two tests. It may be noted that the steering wheel angle A1 rapidly converges towards unsaturated values (at around the 7^{th} second) while the vehicle is still stopped and only the steering wheel is moving. By contrast, it may be noted that, without the system according to the invention (curve B1), the vehicle requires more steering wheel correction in order to achieve a clean command and accurately follow the reference trajectory.

FIG. 5b shows the changes in speed during the two tests. The speed signal B2 is non zero even before the regulator begins to modify the steering wheel angle, following the speed given by the navigation system. On curve A2, with the system according to the invention, the start waits for the steering wheel to have reached a correct angle, which means that it follows the method described hereinabove, activating the initial steering command correction module 37 first of all and then verifying the conditions for activating the other modules. In this instance, the navigation speed is directly exceeded (the position correction module 38 is neglected) from the moment at which the conditions for activating the autonomous cruising driving mode module 39 are obtained (for example from the moment the lateral error is below 0.3 m and the heading or orientation error is below 5 degrees).

FIG. 5c shows the changes in lateral error during the two tests. With implementation of the invention, the vehicle (curve A3) achieves under 0.25 m of lateral error even in difficult contexts such as roundabouts, whereas without the invention, the vehicle (curve B3) exceeds a lateral error of 2.8 m with respect to the roadway. Similar results are shown in FIG. 5d regarding the heading error where with the proposed invention (curve A4) the vehicle maintains a heading error of less than 0.2 radians, which is not the case without the proposed invention (curve B4).

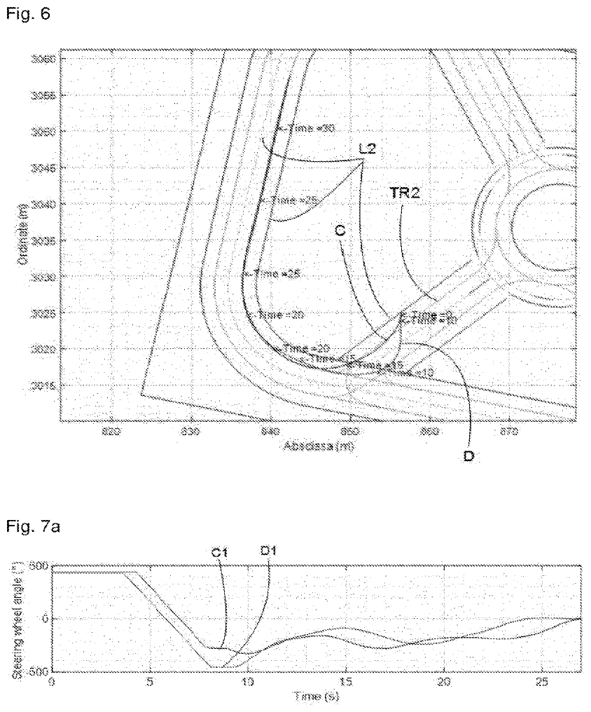

The second test was obtained in the context of a bend. The vehicle starting conditions for the two tests are the same, with a heading error of around 40 degrees with respect to the desired reference trajectory and a steering wheel angle in full left lock (around 480 degrees). FIG. 6 shows the trajectory that the vehicle employs in both instances (trajectory C for the vehicle equipped with the autonomous driving system described hereinabove and trajectory D for the vehicle not equipped with the invention), the limits L2 of the traffic lanes and the desired reference trajectories TR2 for each lane.

In this case, although both trajectories are depicted, only trajectory C can be realized without exceeding the limits (notably without occupying the lane for the oncoming traffic). Trajectory C is executed by the vehicle equipped for implementing the invention. Here, trajectory C rapidly converges towards the desired reference trajectory, without straddling the oncoming lane and bringing the vehicle into normal behavior after around 11 seconds. By contrast, trajectory D represents a vehicle that is not implementing the invention and which stabilizes after around 15 seconds following the start and having clearly straddled the other lane, in other words having departed from the fixed limits.

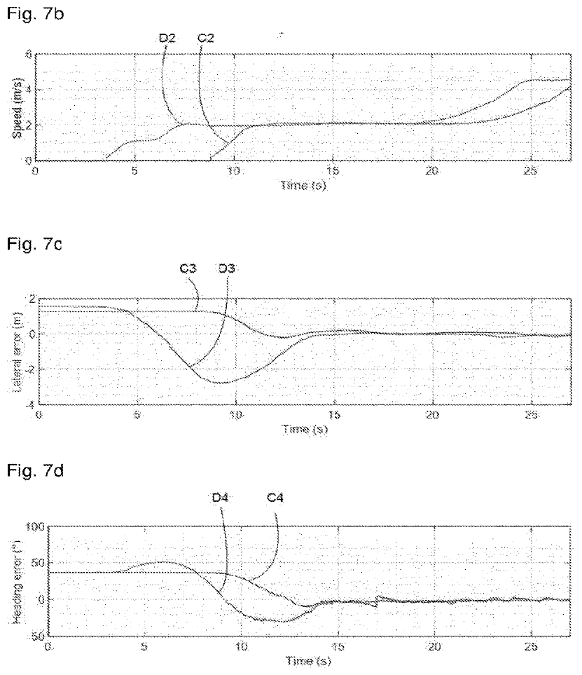

FIGS. 7a, 7b, 7c and 7d depict the performance of the vehicle during the two tests described hereinabove.

FIG. 7a shows the changes in steering wheel angle from an initial value during the two tests. It is clear that the vehicle implementing the invention and following curve C1 more rapidly converges towards unsaturated behavior than the vehicle that does not implement the invention and follows curve D1.

FIG. 7b shows the changes in speed during the two tests. Curve C2 of the speed of the vehicle implementing the invention follows the commands given by the trajectory following module 3, namely, first of all, a zero speed to converge on a correct steering wheel angle then secondly, a speed of 2 m/s is applied, and finally, in the third place, the autonomous cruising driving mode 39 is activated if the orientation and lateral position errors are below predefined thresholds. By contrast, speed curve D2 increases immediately up to 2 m/s. That does not leave the vehicle enough time to be able to converge on a stable state.

FIG. 7c shows the changes in lateral position errors during the course of the two tests. According to curve C3 relating to the vehicle implementing the invention, the initial error of a little under 2 m at the time of initialization is corrected, and the error thereafter does not exceed 0.2 m whereas, on curve D3, relating to the vehicle not implementing the invention, the error reaches around 3 m.

Finally, FIG. 7d shows the changes in heading errors during the two tests. In curve C4 relating to the vehicle implementing the invention, the initial error rapidly converges whereas, in curve D4 relating to the vehicle not implementing the invention, the error increases before later converging toward normal behavior of the vehicle.

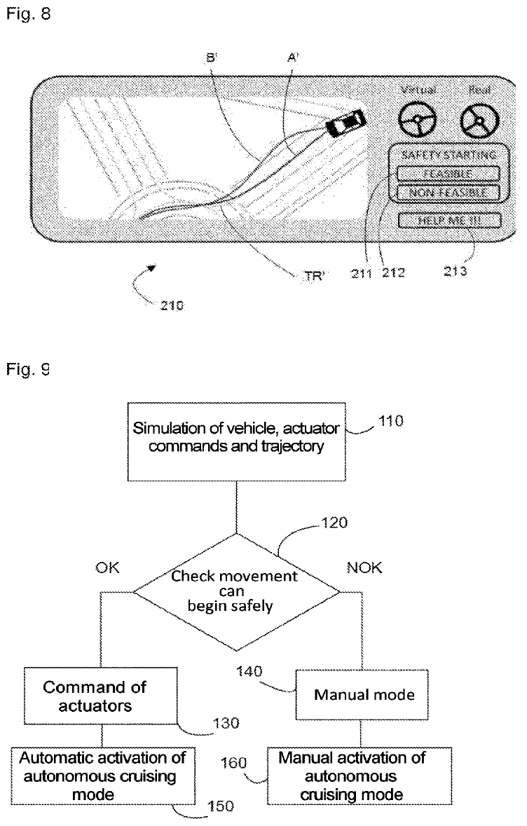

A general illustration of an example of a man-machine interface 210 has been depicted in FIG. 8. The interface is able to inform the passenger or the remote operator as to the feasibility of the maneuvering trajectories and the response of the vehicle with correction to adapt to the given trajectory.

On the interface 210, the trajectory that the vehicle will follow with the initial position and the initial steering wheel angle (trajectory A′ depicted on a map with the desired trajectory TR′ and the driving area) is compared against the trajectory B′ that the vehicle would follow without implementing the invention. As can be seen, the virtual vehicle corrects the orientation of the steered wheels of the vehicle and then the vehicle is moved. The angular position of the virtual steering wheel can be indicated on the interface 210, as can the current angular position of the steering wheel.

If the trajectory verified by the start validation module 1 is feasible, an indication 211, such as a lamp 211, may be displayed on the interface.

If the trajectory verified by the start validation module 1 is not feasible, an indication 212, such as a lamp 212, may be displayed on the interface.

If several tests are executed without any possible trajectory being found, an indication 213, such as a lamp 213, may be displayed on the interface.

The interface is therefore able to indicate how the vehicle is going to manage a complex maneuver situation autonomously.

The advantage of the solutions described hereinabove is that they increase the capabilities of the vehicles, notably of the robot taxi type. Such vehicles have difficulties starting in curved zones or where there is an appreciable lateral position or orientation error with respect to a reference trajectory supplied by an autonomous cruising driving system. The solutions described above also enable management of a pulling-in, pulling-out or remote operated maneuver which represent maneuvers that are complex for an autonomous vehicle to manage.

1-10. (canceled)

11. A method for autonomous maneuvering driving of a motor vehicle, comprising:
modifying an orientation of steered wheels of the vehicle while a speed of the vehicle is zero or substantially zero or below or equal to a threshold.

12. The method as claimed in claim 11, wherein the threshold is equal to 1 km/h.

13. A method for autonomous driving of a motor vehicle, comprising:
implementing an autonomous maneuvering driving mode according to the method as claimed in claim 11; and
implementing an autonomous cruising driving mode for cruising along a cruise trajectory,
wherein the two autonomous driving modes are exclusive.

14. The method as claimed in claim 13, wherein
an operating logic for the autonomous maneuvering driving mode and for the autonomous cruising driving mode are different; or
in the autonomous maneuvering driving mode the vehicle is driven or moved at a speed below 10 km/h.

15. The method as claimed in claim 13, further comprising:
defining a reference cruise trajectory, and
defining, iteratively and/or by simulation, a maneuvering trajectory to meet the reference cruise trajectory from an initial position of the vehicle.

16. The method as claimed in claim 15, further comprising:
validating the maneuvering trajectory with respect to at least one of:
physical maneuvering capabilities of the vehicle, and
safety of assets and/or individuals in the vehicle and/or in a vicinity of the vehicle.

17. The method as claimed in claim 15, further comprising:
determining or measuring a current position of the vehicle;
comparing the current position of the vehicle and positions that make up the reference trajectory; and
automatically switching over from the autonomous maneuvering driving mode to the autonomous cruising driving mode when the current position of the vehicle corresponds to one of the positions that make up the reference trajectory.

18. A system for the autonomous driving of a motor vehicle, the system comprising hardware and software elements that are configured to implement the method as claimed in claim 11.

19. A motor vehicle, comprising hardware and software elements that are configured to implement the method as claimed in claim 11.

20. A non-transitory computer readable medium storing a computer program that, when executed by a computer, causes the computer to execute the method as claimed in claim 11.
